(19) United States
(12) Patent Application Publication
(10) Pub. No.: US 2007/0269073 A1
(43) Pub. Date: Nov. 22, 2007

(54) Earphone with microphone

(75) Inventor: Kuan-Di Huang, Taoyuan County (TW)

Correspondence Address: BACON & THOMAS, PLLC, 625 SLATERS LANE, FOURTH FLOOR, ALEXANDRIA, VA, 22314, US

(73) Assignees: Kuan-Di Huang, Taoyuan County (TW); HALLOA ENTERPRISE CO., LTD., Sanchong City (TW)

(21) Appl. No.: 11/451,335

(22) Filed: Jun. 13, 2006

(30) Foreign Application Priority Data
May 19, 2006 (TW) 095208640

(51) Int. Cl. H04R 25/00

(52) U.S. Cl. 381/380; 381/190; 381/371

(57) ABSTRACT

The present invention to provide an earphone comprising a casing, a loudspeaker provided in the casing and adapted to amplify sound in response to receiving a voice source signal, a cap fixedly mounted onto the casing, a piezoelectric microphone provided in the cap and a sound barrier member provided between the piezoelectric microphone and the loudspeaker, wherein the sound barrier member has a diameter larger than that of the piezoelectric microphone but smaller than that of the loudspeaker such that sound amplified by the loudspeaker is adapted to transmit beyond the cap through the sound barrier member and sound vibrations transmitted to the piezoelectric microphone are substantially absorbed. Thus, sound amplified by the loudspeaker does not interfere with the external sound receiving capability of the piezoelectric microphone.

### FIELD OF THE INVENTION

The present invention relates to earphones and more particularly to such an earphone having a microphone with improved characteristics.

### BACKGROUND OF THE INVENTION

The world has entered into a new era with information technology being progressed rapidly. Also, the electronic industry has known a rapid, spectacular development in recent several decades. Various computer related new products are commercially available as the Internet and mobile communications have made phenomenal strides in commercial operations in the world. As a result, many types of fully functional, compact high-technology products including mobile communications devices are available in an affordable price. For example, up-to-date mobile phones are very compact, visually attractive, and multi-functional, and have a high storage capacity. In addition to basic mobile communications capability, mobile phones may incorporate other useful features (e.g., scheduler, calculator, calendar, camera, video games, recorder, etc.). A type of product capable of operating in cooperation with a mobile phone is developed by manufacturers of the art. With the product, a person may use a mobile phone any time, any place. This is a great convenience to mobile phone users.

One popular type of product as available is a hands-free kit for use with a mobile phone in car. The hands-free kit comprises an earphone and a microphone. The earphone is inserted into the ear for listening to an incoming call or music played by operating the mobile phone. The microphone is held and is disposed proximate the mouth for amplifying voice or music. For example, a driver may not have to use one hand to hold the mobile phone to receive an incoming call in response to the incoming call while driving. To the contrary, the drive may simply use one hand to hold the steering wheel for continuing the driving. As an end, driving safety is well maintained. However, the prior art suffered a disadvantage. In detail, the driver may hear both voice of the call and environmental noise including engine noise, music, etc. since the microphone is held to the body (e.g., the head) of the driver. As a result, voice quality of the communication as heard by the called party is very poor.

For solving the above problem, a hands-free kit having a throat type microphone is developed by some manufacturer of the art as shown in FIG. 1. The hands-free kit comprises an arcuate band 10, a throat type microphone 11, and an earphone 12. The band 10 is held to the neck. The throat type microphone 11 is provided at one end of the band 10. The earphone 12 is connected to one end of the band 10 by a cable 13. Thus, the earphone 12 is adapted to output voice in response to a received call. Further, vibrations generated by the throat are transmitted to the throat type microphone 11 when the driver is speaking since the throat type microphone 11 is held to the neck proximate the throat. This prior art hands-free kit has the advantage of substantially isolating noise from being heard, resulting in a complete transmission of the driver voice to the calling party. However, the prior art still suffered from several disadvantages. In detail, the hands-free kit is held to the neck. Hence, the driver may feel a great degree of discomfort. Further, the cable 13 cannot be wound inside an automatic winding device for earphone cable. As such, the cable 13 tends to entangle. Furthermore, the cable 13 may disengage with the earphone 12 or even be damaged.

For solving the problem detailed above, a hands-free kit having a microphone is developed by some manufacturer of the art as shown in FIG. 2. The hands-free kit comprises a casing 2 inserted into the ear and having one end formed as an opening 20. Within the casing 2, there are provided a microphone 21, a loudspeaker 22, and two cables 23. The microphone 21 is provided at one end of the casing 2. Vibrations generated by vocal cords in the throat are transmitted to the ear through Eustachian tube when a driver is speaking. And in turn, the microphone 21 is adapted to amplify the vibrations (i.e., sound) transmitted by the ear. The loudspeaker 22 is provided in an intermediate portion of the casing 2 and is adapted to amplify the sound to a desire level for hearing. One ends of the two cables 23 are connected to the microphone 21 and the loudspeaker 22 respectively and the other ends thereof are extended out of the other end of the casing 2. By configuring as above, the hands-free kit serves for both sound amplification and voice receiving. Further, the cables 23 are adapted to wind inside an automatic winding device for earphone cable. As an end, the hands-free kit is easy to carry and occupies a minimum space.

However, the prior art hands-free kit having a microphone still suffered from a disadvantage. For example, too much echo is received by the microphone 21 when the driver is speaking to a calling party. As shown in FIG. 2 again, the microphone 21 not only receives sound vibrations transmitted from the ear to its surrounding but also receives sound transmitted from the Eustachian tube. As such, voice quality as received is poor because too much echo is received by the microphone 21. Thus, transmitted voice is mixed with noise, resulting in great difficulties of clearly hearing the conversation by the called party. Also, the called party has great difficulties of identifying the calling party. This in turn wastes a lot of time in the conversation. Thus, it is desirable among manufacturers of the art to overcome the inadequacies of the two prior art hands-free kits, eliminate interference, increase voice quality of the conversation, and facilitate carrying.

### SUMMARY OF THE INVENTION

After considerable research and experimentation, an earphone with microphone according to the present invention has been devised having the advantages of increased voice quality of telephone conversation and ease of carrying so as to overcome the above drawbacks of the prior art including interference, difficulty of carrying, etc.

It is an object of the present invention to provide an earphone comprising a casing, a loudspeaker, a cap, a piezoelectric microphone and a sound barrier member. The loudspeaker is provided in the casing. The loudspeaker is adapted to amplify sound in response to receiving a voice source signal. The piezoelectric microphone is provided in the cap. The sound barrier member is provided between the piezoelectric microphone and the loudspeaker. The sound barrier member has a diameter larger than that of the piezoelectric microphone but smaller than that of the loudspeaker such that sound amplified by the loudspeaker is adapted to transmit beyond the cap through the sound barrier member and sound vibrations transmitted to the piezoelectric microphone are substantially absorbed. Thus, sound amplified by the loudspeaker does not interfere with the external sound receiving capability of the piezoelectric microphone. The cap is adhered to the ear drum when the earphone is inserted into the ear. Sound vibrations generated by the ear drum are transmitted to the piezoelectric microphone through the cap. Next, the piezoelectric microphone generates an analog signal output. By utilizing this earphone, the earphone serves for both sound amplification and voice receiving.

It is another object of the present invention to provide an earphone comprising a casing, a cap fixedly mounted onto one end of the casing, a piezoelectric microphone is provided in the cap, a loudspeaker provided in the cap, the loudspeaker adapted to amplify sound in response to receiving a voice source signal, and a sound barrier member provided between the piezoelectric microphone and the loudspeaker. The sound barrier member has a diameter larger than that of the piezoelectric microphone such that sound vibrations transmitted from the loudspeaker to the piezoelectric microphone are substantially absorbed by the sound barrier member. Thus, sound amplified by the loudspeaker does not interfere with the external sound receiving capability of the piezoelectric microphone. The casing is adhered to the ear drum when the earphone is inserted into the ear. Sound vibrations generated by the ear drum are transmitted to the piezoelectric microphone through the casing. Next, the piezoelectric microphone generates an analog signal output. By utilizing this earphone, the earphone serves for both sound amplification and voice receiving.

The above and other objects, features and advantages of the present invention will become apparent from the following detailed description taken with the accompanying drawings.

### BRIEF DESCRIPTION OF THE DRAWINGS

FIG. 1 is a perspective view of a conventional hands-free kit having a throat type microphone;

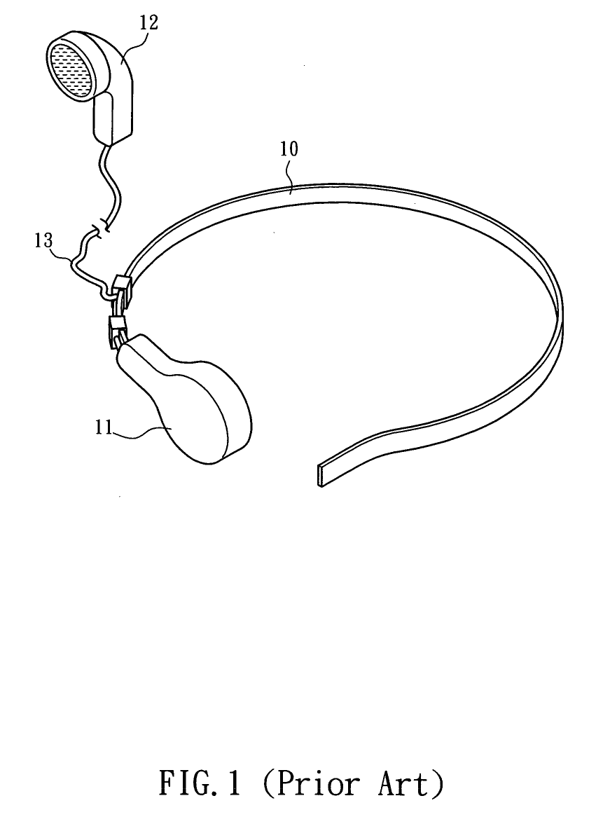

FIG. 2 is a sectional view of another conventional hands-free kit having a microphone;

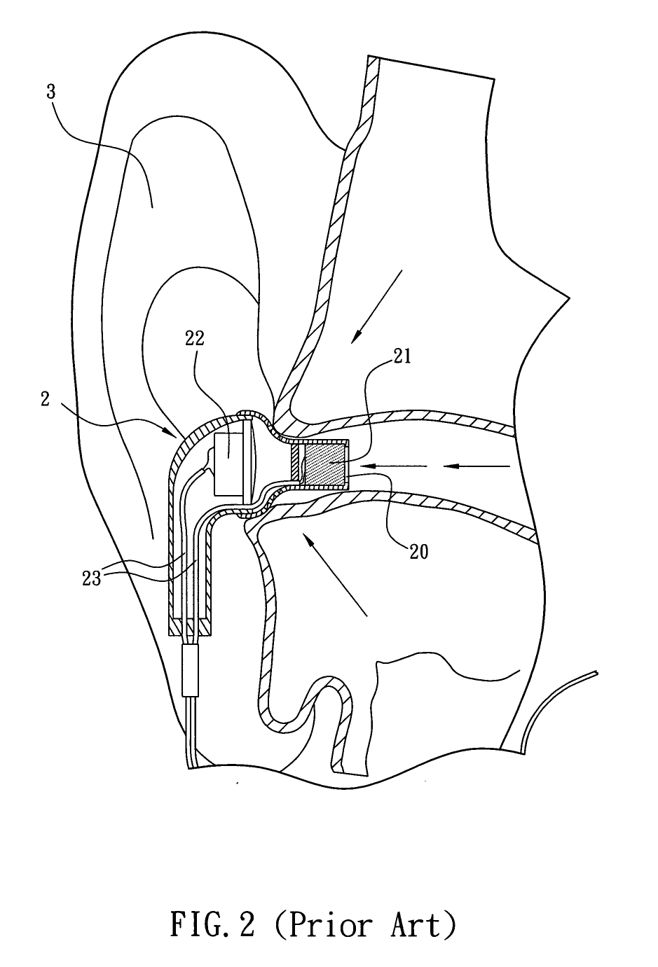

FIG. 3 is a sectional view of a first preferred embodiment of earphone according to the invention;

FIG. 4 is a sectional view of a second preferred embodiment of earphone according to the invention;

FIG. 5 is a sectional view of a third preferred embodiment of earphone according to the invention; and

FIG. 6 is a sectional view of a fourth preferred embodiment of earphone according to the invention.

### DETAILED DESCRIPTION OF THE PREFERRED EMBODIMENTS

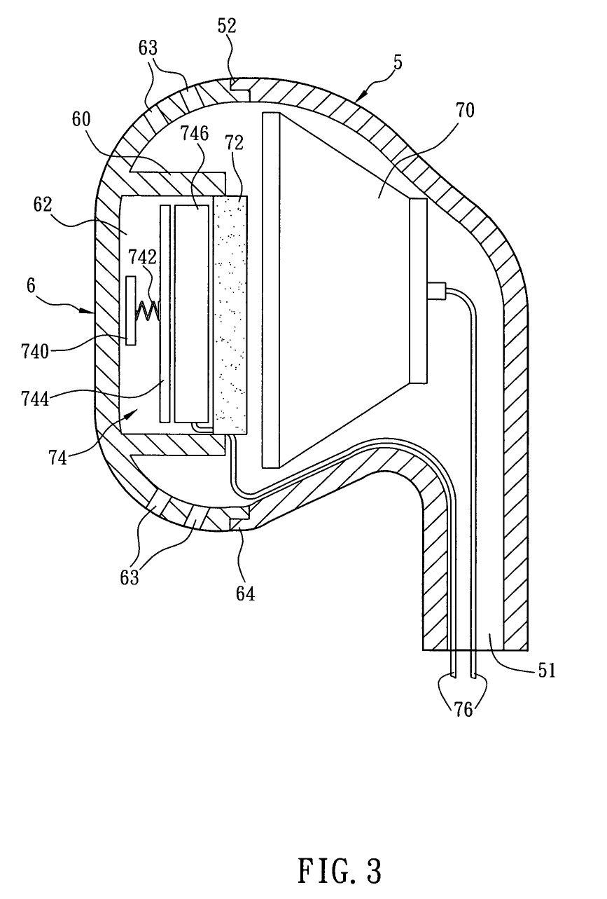

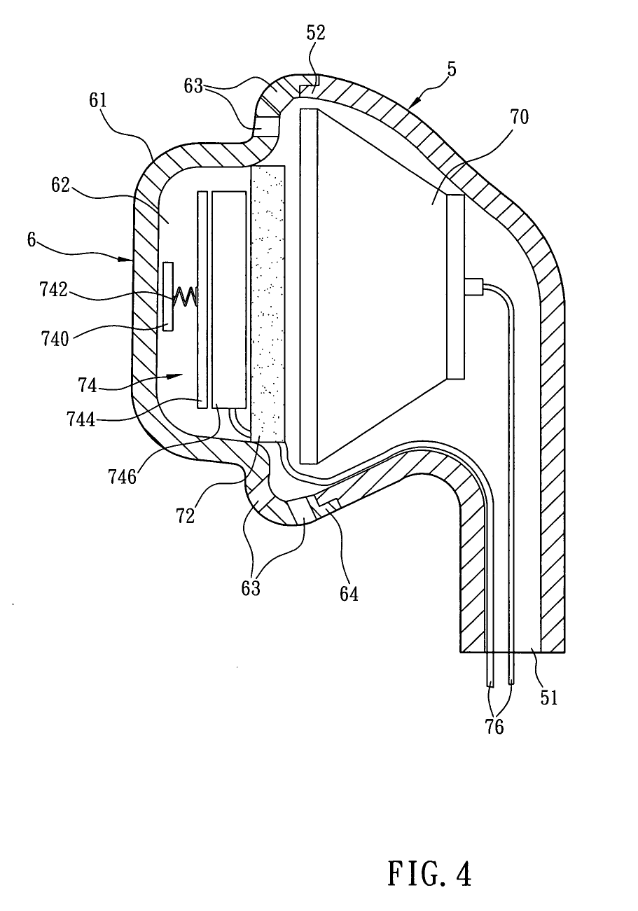

Referring to FIGS. 3 and 4, an earphone having a microphone in accordance with the invention is shown. The earphone comprises a casing 5, a loudspeaker 70 provided in the casing 5, the loudspeaker 70 adapted to amplify sound in response to receiving a voice source signal, a cap 6 fixedly mounted onto the casing 5, a piezoelectric microphone 74 provided in the cap 6, and a sound barrier member 72 provided between the piezoelectric microphone 74 and the loudspeaker 70, the sound barrier member 72 having a diameter larger than that of the piezoelectric microphone 74 but smaller than that of the loudspeaker 70 such that sound amplified by the loudspeaker 70 is adapted to transmit beyond the cap 6 through the sound barrier member 72 and sound vibrations transmitted to the piezoelectric microphone 74 are substantially absorbed. Thus, sound amplified by the loudspeaker 70 may not interfere with the external sound receiving capability of the piezoelectric microphone 74. The cap 6 is adhered to the ear drum when the earphone is inserted into the ear. Sound vibrations generated by the ear drum are transmitted to the piezoelectric microphone 74 through the cap 6. Next, the piezoelectric microphone 74 generates an analog signal output. By configuring as above, the earphone serves for both sound amplification and voice receiving.

Referring to FIG. 3 again, a first preferred embodiment of the invention is shown. The cap 6 comprises an internal annular flange 60 facing the casing 5, the annular flange 60 having a space 60 for receiving the piezoelectric microphone 74. As such, the piezoelectric microphone 74 is concealed in the cap 6 and is prevented from receiving external noise, wind sound, etc. Further, sound amplified by the loudspeaker 70 is separated from the sound barrier member 72. Thus, the piezoelectric microphone 74 only receives sound vibrations transmitted by the ear drum. This is a contrast to the prior art hands-free kit having a microphone which experiences an unclear conversation because too much echo is received.

Referring to FIG. 4 again, a second preferred embodiment of the invention is shown. The cap 6 comprises a hollow raised member 61, the hollow raised member 61 projecting out of an outer surface of the cap 6 away from the casing 5, the hollow raised member 61 having a space 62 for receiving the piezoelectric microphone 74. As such, the piezoelectric microphone 74 is concealed in the cap 6 by both the hollow raised member 61 and the sound barrier member 72, and is prevented from receiving external noise, wind sound, etc. Further, sound vibrations transmitted to the piezoelectric microphone 74 are substantially absorbed by the sound barrier member 72. Thus, the piezoelectric microphone 74 only receives sound vibrations transmitted by the ear drum. As an end, received voice is clear.

Referring to FIGS. 3 and 4 again, in the above embodiments the cap 6 further comprises a plurality of spaced apertures 63 provided around and proximate a periphery of the cap 6. Thus, sound amplified by the loudspeaker 70 is transmitted beyond the cap 6 for user listening through a periphery of the sound barrier member 72 and the apertures 63.

Referring to FIGS. 3 and 4 again, in the above embodiments an external portion of the casing 5 is bent and is extended a predetermined distance. An opening 51 is provided at an open end of the external portion of the casing 5. The opening 51 is in communication with the internal space of the casing 5. Also, two cables 76 are provided in the casing 5. One ends of the cables 76 are connected to the piezoelectric microphone 74 and the loudspeaker 70 respectively and the other ends thereof are extended beyond the casing 5 through the opening 51. Thus, the other ends of the cables 76 can be connected to an electronic device (not shown) for receiving a voice source signal therefrom. Also, an analog output signal is transmitted from the piezoelectric microphone 74 to the electronic device for converting into an audio signal at the electronic device.

Referring to FIGS. 3 and 4 again, in the above embodiments an annular first projection 52 is formed on a periphery of the casing 5. Correspondingly, an annular second projection 62 is formed on a periphery of the cap 6. The annular second projection 62 is adapted to matingly engage with the annular first projection 52 for securing the cap 6 to one end of the casing 5.

Referring to FIGS. 3 and 4 again, in the above embodiments the piezoelectric microphone 74 comprises a sense piece 740, an elastic member (e.g., spring as shown) 742, a voltage generation member 744, and a circuit board 746. The sense piece 740 is proximate the cap 6. One end of the elastic member 742 is connected to the sense piece 740. Sound vibrations generated by the ear drum are transmitted to the voltage generation member 744 through the sense piece 740 and the elastic member 742 sequentially. The voltage generation member 744 outputs sense signals of different voltages in response to amplitudes of the transmitted sound vibrations. The circuit board 746 is electrically connected to the voltage generation member 744 and the other end of one cable 76 respectively. The circuit board 746 receives the sense signals and then generates analog signals which are in turn transmitted to one cable 76. By configuring as above, the analog signals transmitted to the electronic device are then converted into audio signals. As an end, a clear voice is rendered.

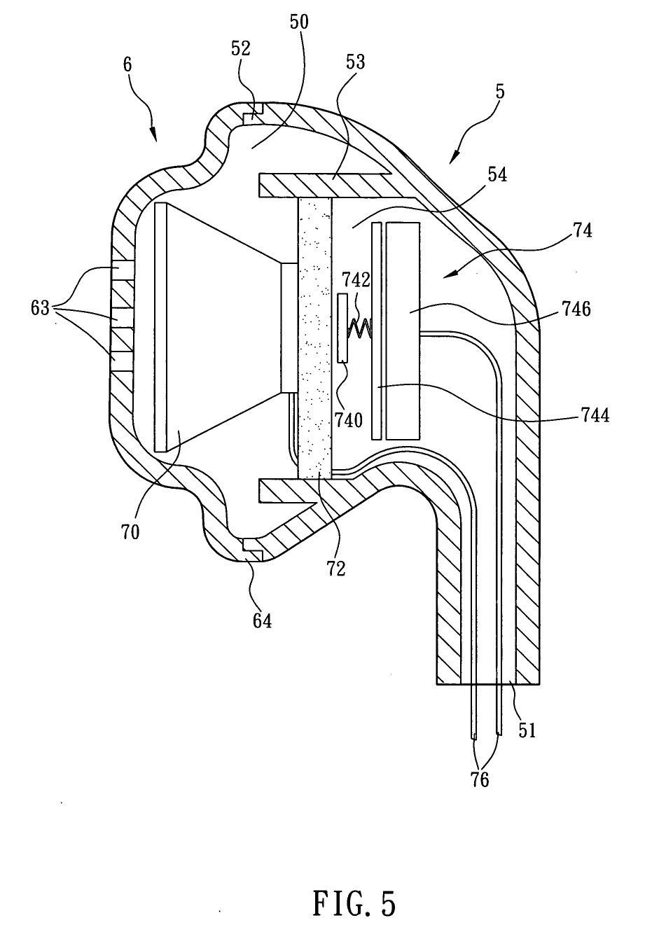

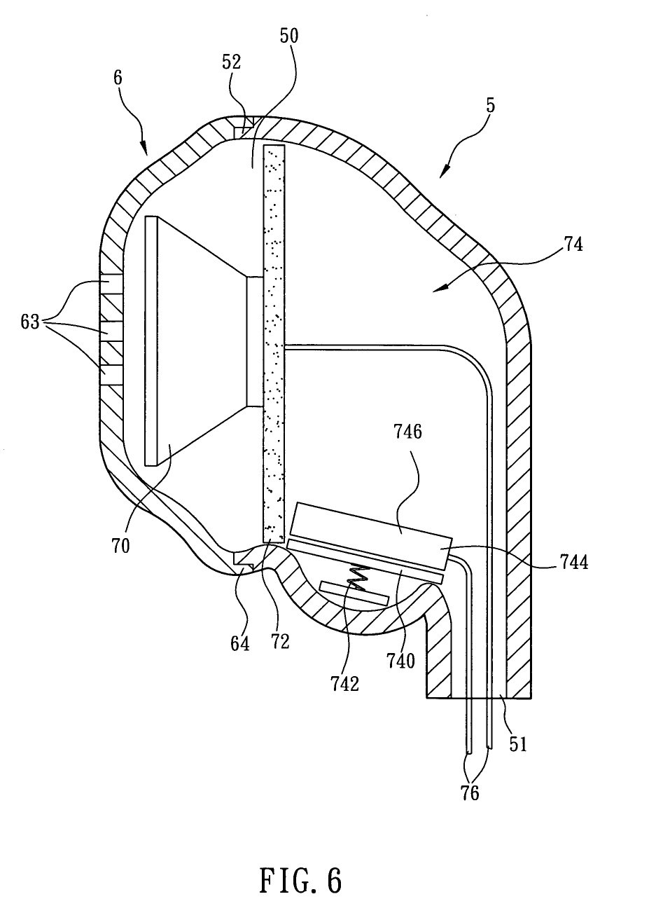

Referring to FIGS. 5 and 6, an earphone having a microphone according to the invention is shown. The earphone comprises a casing 5, a piezoelectric microphone 74 provided in the casing 5, one end of the casing 5 fixedly mounted onto a cap 6, a loudspeaker 70 provided in the cap 6, the loudspeaker 70 adapted to amplify sound in response to receiving a voice source signal, and a sound barrier member 72 provided between the piezoelectric microphone 74 and the loudspeaker 70, the sound barrier member 72 having a diameter larger than that of the piezoelectric microphone 74 such that sound vibrations transmitted from the loudspeaker 70 to the piezoelectric microphone 74 are substantially absorbed by the sound barrier member 72 and sound amplified by the loudspeaker 70 may not interfere with the external sound receiving capability of the piezoelectric microphone 74. The casing 5 is adhered to the ear drum when the earphone is inserted into the ear. Sound vibrations generated by the ear drum are transmitted to the piezoelectric microphone 74 through the casing 5. Next, the piezoelectric microphone 74 generates an analog signal output. By configuring as above, the earphone serves for both sound amplification and voice receiving.

Referring to FIG. 5 again, in a third preferred embodiment of the invention is shown. The casing 5 comprises an internal annular flange 53, the annular flange 53 having a space 54 for receiving the piezoelectric microphone 74. As such, the piezoelectric microphone 74 is concealed in the cap 6 by both the annular flange 53 and the sound barrier member 7 and is prevented from receiving external noise, wind sound, etc. Further, sound vibrations transmitted to the piezoelectric microphone 74 are substantially absorbed by the sound barrier member 72. Thus, the piezoelectric microphone 74 only receives sound vibrations transmitted by the ear drum. This is a contrast to the prior art hands-free kit having a microphone which experiences an unclear conversation because too much echo is received.

Referring to FIG. 6 again, in a fourth preferred embodiment of the invention a periphery of the sound barrier member 72 is engaged with an inner face of a periphery of the casing 5. Thus, sound amplified by the loudspeaker 70 in the cap 6 is prevented from transmitting beyond the casing 5. Sound amplified by the loudspeaker 70 may not interfere with the external sound receiving capability of the piezoelectric microphone 74. The other end of the casing 5 is projected out of its one end. The piezoelectric microphone 74 is provided in the casing 5 proximate its one end and is engaged with a periphery of the casing 5. Hence, sound vibrations generated by the ear drum are transmitted to the piezoelectric microphone 74 through the casing 5. Thus, the piezoelectric microphone 74 only receives sound vibrations transmitted from the ear drum.

Referring to FIGS. 5 and 6 again, in the above embodiments the cap 6 comprises a plurality of apertures 63 on its center, the apertures 63 aligned with the loudspeaker 70 such that sound amplified by the loudspeaker 70 is transmitted beyond the cap 6 for user listening through the apertures 63.

Referring to FIGS. 5 and 6 again, in the above embodiments an external portion of the casing 5 is bent and is extended a predetermined distance. An opening 51 is provided at an open end of the external portion of the casing 5. The opening 51 is in communication with the internal space of the casing 5. Also, two cables 76 are provided in the casing 5. One ends of the cables 76 are connected to the piezoelectric microphone 74 and the loudspeaker 70 respectively and the other ends thereof are extended beyond the casing 5 through the opening 51. Thus, the other ends of the cables 76 can be connected to an electronic device (not shown) for receiving a voice source signal therefrom. Also, an analog output signal is transmitted from the piezoelectric microphone 74 to the electronic device for converting into an audio signal at the electronic device.

Referring to FIGS. 5 and 6 again, in the above embodiments an annular first projection 52 is formed on a periphery of the casing 5. Correspondingly, an annular second projection 62 is formed on a periphery of the cap 6. The annular second projection 62 is adapted to matingly engage with the annular first projection 52 for securing the cap 6 to one end of the casing 5.

Referring to FIGS. 5 and 6 again, in the above embodiments the piezoelectric microphone 74 comprises a sense piece 740, an elastic member (e.g., spring as shown) 742, a voltage generation member 744, and a circuit board 746. The sense piece 740 is distal the cap 6. One end of the elastic member 742 is connected to the sense piece 740 and the other end thereof is connected to the voltage generation member 744. Sound vibrations generated by the ear drum are transmitted to the voltage generation member 744 through the sense piece 740 and the elastic member 742 sequentially. The voltage generation member 744 outputs sense signals of different voltages in response to amplitudes of the transmitted sound vibrations. The circuit board 746 is electrically connected to the voltage generation member 744 and the other end of one cable 76 respectively. The circuit board 746 receives the sense signals and then generates analog signals which are in turn transmitted to one cable 76. By configuring as above, the analog signals transmitted to the electronic device are then converted into audio signals. As an end, a clear voice is rendered.

While the invention herein disclosed has been described by means of specific embodiments, numerous modifications and variations could be made thereto by those skilled in the art without departing from the scope and spirit of the invention set forth in the claims.

What is claimed is:

1. An earphone comprising:
a casing;
a loudspeaker provided in the casing;
a cap fixedly mounted onto the casing, the cap shaped and dimensioned to adhere to the ear drum when the earphone is inserted into the ear;
a piezoelectric microphone provided in the cap; and
a sound barrier member provided between the piezoelectric microphone and the loudspeaker, the sound barrier member having a diameter larger than that of the piezoelectric microphone but smaller than that of the loudspeaker.

2. The earphone of claim 1, wherein the cap comprises an internal annular flange facing the casing, the flange having a space for receiving the piezoelectric microphone.

3. The earphone of claim 1, wherein the cap comprises a hollow raised member projecting out of its outer surface away from the casing, the raised member having a space receiving the piezoelectric microphone.

4. The earphone of claim 2, wherein the cap further comprises a plurality of spaced apertures provided around and proximate its periphery.

5. The earphone of claim 3, wherein the cap further comprises a plurality of spaced apertures provided around and proximate its periphery.

6. The earphone of claim 4, wherein the casing comprises a bent external portion extended a predetermined distance outwardly, the external portion of the casing including an opening formed at its open end, the opening being in communication with the internal space of the casing.

7. The earphone of claim 5, wherein the casing comprises a bent external portion extended a predetermined distance outwardly, the external portion of the casing including an opening formed at its open end, the opening being in communication with the internal space of the casing.

8. The earphone of claim 6, further comprising two cables provided in the casing, and wherein one ends of the cables are connected to the piezoelectric microphone and the loudspeaker respectively and the other ends thereof are extended beyond the casing through the opening to connect to an electronic device.

9. The earphone of claim 7, further comprising two cables provided in the casing, and wherein one ends of the cables are connected to the piezoelectric microphone and the loudspeaker respectively and the other ends thereof are extended beyond the casing through the opening to connect to an electronic device.

10. The earphone of claim 8, wherein the casing further comprises an annular first projection formed on its periphery, and the cap further comprises an annular second projection formed on its periphery, the second projection adapted to matingly engage with the first projection for securing the cap to one end of the casing.

11. The earphone of claim 9, wherein the casing further comprises an annular first projection formed on its periphery, and the cap further comprises an annular second projection formed on its periphery, the second projection adapted to matingly engage with the first projection for securing the cap to one end of the casing.

12. The earphone of claim 10, wherein the piezoelectric microphone comprises:
a sense piece provided proximate the cap;
an elastic member having one end connected to the sense piece;
a voltage generation member connected to the other end of the elastic member, the voltage generation member adapted to output sense signals of different voltages; and
a circuit board electrically connected to the voltage generation member and the other end of one cable respectively, the circuit board adapted to receive the sense signals and generate analog signals which are transmitted to one cable.

13. The earphone of claim 11, wherein the piezoelectric microphone comprises:
a sense piece provided proximate the cap;
an elastic member having one end connected to the sense piece;
a voltage generation member connected to the other end of the elastic member, the voltage generation member adapted to output sense signals of different voltages; and
a circuit board electrically connected to the voltage generation member and the other end of one cable respectively, the circuit board adapted to receive the sense signals and generate analog signals which are transmitted to one cable.

14. An earphone comprising:
a casing shaped and dimensioned to adhere to the ear drum when the earphone is inserted into the ear;
a cap fixedly mounted onto one end of the casing;
a loudspeaker provided in the cap;
a piezoelectric microphone provided in the casing; and
a sound barrier member provided between the piezoelectric microphone and the loudspeaker, the sound barrier member having a diameter larger than that of the piezoelectric microphone.

15. The earphone of claim 14, wherein the casing comprises an internal annular flange having a space for receiving the piezoelectric microphone.

16. The earphone of claim 14, wherein the other end of the casing is projected out of its one end, and wherein the piezoelectric microphone is engaged with a periphery of the casing.

17. The earphone of claim 16, wherein a periphery of the sound barrier member is engaged with an inner face of the periphery of the casing.

18. The earphone of claim 15, wherein the cap comprises a plurality of apertures aligned with the loudspeaker.

19. The earphone of claim 17, wherein the cap comprises a plurality of apertures aligned with the loudspeaker.

20. The earphone of claim 18, wherein the casing further comprises a bent external portion extended a predetermined distance outwardly, the external portion of the casing including an opening formed at its open end, the opening being in communication with the internal space of the casing.

21. The earphone of claim 19, wherein the casing further comprises a bent external portion extended a predetermined distance outwardly, the external portion of the casing including an opening formed at its open end, the opening being in communication with the internal space of the casing.

22. The earphone of claim 20, further comprising two cables provided in the casing, and wherein one ends of the cables are connected to the piezoelectric microphone and the loudspeaker respectively and the other ends thereof are extended beyond the casing through the opening to connect to an electronic device.

23. The earphone of claim 21, further comprising two cables provided in the casing, and wherein one ends of the cables are connected to the piezoelectric microphone and the loudspeaker respectively and the other ends thereof are extended beyond the casing through the opening to connect to an electronic device.

24. The earphone of claim 22, wherein the casing further comprises an annular first projection formed on its periphery, and the cap further comprises an annular second projection formed on its periphery, the second projection adapted to matingly engage with the first projection for securing the cap to one end of the casing.

25. The earphone of claim 23, wherein the casing further comprises an annular first projection formed on its periphery, and the cap further comprises an annular second projection formed on its periphery, the second projection adapted to matingly engage with the first projection for securing the cap to one end of the casing.

26. The earphone of claim 24, wherein the piezoelectric microphone comprises:
a sense piece provided distal the cap;
an elastic member having one end connected to the sense piece;
a voltage generation member connected to the other end of the elastic member, the voltage generation member adapted to output sense signals of different voltages; and
a circuit board electrically connected to the voltage generation member and the other end of one cable respectively, the circuit board adapted to receive the sense signals and generate analog signals which are transmitted to one cable.

27. The earphone of claim 25, wherein the piezoelectric microphone comprises:
a sense piece provided distal the cap;
an elastic member having one end connected to the sense piece;
a voltage generation member connected to the other end of the elastic member, the voltage generation member adapted to output sense signals of different voltages; and
a circuit board electrically connected to the voltage generation member and the other end of one cable respectively, the circuit board adapted to receive the sense signals and generate analog signals which are transmitted to one cable.
